(19) United States
(12) Patent Application Publication
(10) Pub. No.: US 2009/0132759 A1
(43) Pub. Date: May 21, 2009

(54) Information processing apparatus and method for controlling information processing apparatus

(75) Inventors: Hiroki Kimura, Chiba (JP); Tetsuo Kaneko, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/289,368

(22) Filed: Oct. 27, 2008

(30) Foreign Application Priority Data
Nov. 19, 2007 (JP) 2007-299569

(51) Int. Cl. G06F 12/08

(52) U.S. Cl. 711/105; 711/E12.017

(57) ABSTRACT

Disclosed herein is an information processing apparatus including: a dynamic random access memory; a memory controller that manages accesses to the dynamic random access memory on a bank basis; a cache memory that is connected to the memory controller via a bus and which caches data stored in the dynamic random access memory; and an information processing block that performs a read access to the dynamic random access memory via the cache memory. The cache memory includes: a refill request generation section configured to generate a refill request for caching the data stored in the dynamic random access memory in response to a cache miss for the read access; and a read access section configured to, when the refill requests have been accumulated for a predetermined number of banks, perform a read access to the dynamic random access memory while combining the refill requests for the predetermined number of banks.

### CROSS REFERENCES TO RELATED APPLICATIONS

The present invention contains subject matter related to Japanese Patent Application JP 2007-299569, filed in the Japan Patent Office on Nov. 19, 2007, the entire contents of which being incorporated herein by reference.

### BACKGROUND OF THE INVENTION

1. Field of the Invention

The present invention relates to an information processing apparatus including an information processing block that accesses a dynamic random access memory via a cache memory, and a method for controlling this information processing apparatus.

2. Description of the Related Art

Image compression technologies typified by Moving Picture Experts Group 2 (MPEG-2) have advanced and are now used in a variety of applications. Image data encoded in accordance with the MPEG-2 are decoded on a macroblock basis. Specifically, in a process related to encoding, a discrete cosine transform (DCT) coefficient and a motion vector are separated from image data of a current macroblock that has been subjected to a variable-length decoding process. Here, in the case of an intra macroblock, the DCT coefficient is subjected to inverse DCT transform to obtain an original image. Meanwhile, in the case of a non-intra macroblock, predicted macroblocks, for example, are read from a frame memory in numerical order, and each predicted macroblock is added to image data of a corresponding current macroblock that has been subjected to the inverse DCT transform. Then, the decoded macroblock is outputted and is also transferred to the frame memory and stored therein.

In the above procedure, the predicted macroblocks are read from the frame memory on a macroblock basis, for example. The frame memory is typically formed by a dynamic random access memory (DRAM), in which each line is divided into approximately two or three pages, leading to discontinuity in read addresses and a problem of a high frequency of occurrence of memory page misses.

The macroblocks are stored in the frame memory, and at the time of storing the macroblocks in the frame memory, write addresses become discontinuous very often, increasing the probability of the occurrence of the memory page misses, and since the data is transferred on a macroblock basis, a utilization ratio of a bandwidth of the frame memory becomes low.

In this connection, Japanese Patent Laid-open No. 2000-175201 describes an image processing apparatus that improves the utilization ratio of the bandwidth of a memory that stores the data on a frame basis, by decoding input image data on a slice basis and transferring the decoded image data to the DRAM on a slice basis. In this image processing apparatus, image data of the predicted macroblocks corresponding to the non-intra macroblocks are transferred in the order of addresses in the memory that stores the data on a frame basis, resulting in a reduced frequency of the occurrence of the page misses.

However, this image processing apparatus requires a large capacity cache memory capable of storing one slice of image data. In addition, although this image processing apparatus is capable of reducing the frequency of the occurrence of the page misses, no attempt is made to avoid a decrease in the utilization ratio of the bandwidth of the frame memory because of the occurrence of the page misses. Still further, in this image processing apparatus, accesses are made with a long transfer length of one page. Therefore, in the case where the frame memory is implemented by using a system memory such as the DRAM, if such an access conflicts with an access from another bus master to the system memory and an access wait occurs, a processing ability of a whole system is reduced.

### SUMMARY OF THE INVENTION

The present invention addresses the above-identified, and other problems associated with existing methods and apparatuses, and provides an information processing apparatus that improves the utilization ratio of the bandwidth of the dynamic random access memory, and a method for controlling this information processing apparatus.

According to one embodiment of the present invention, there is provided an information processing apparatus including: a dynamic random access memory that is composed of a plurality of storage elements and which requires a precharge operation of charging each of the storage elements for data storage; a memory controller configured to manage accesses to the dynamic random access memory on a bank basis, a storage area of the dynamic random access memory being divided into a plurality of banks; a cache memory connected to the memory controller via a bus and configured to cache data stored in the dynamic random access memory; and an information processing block configured to perform a read access to the dynamic random access memory via the cache memory. The cache memory includes: a refill request generation section configured to generate a refill request for caching the data stored in the dynamic random access memory in response to occurrence of a cache miss for the read access performed by the information processing block, the refill request being targeted at one or more of the banks of the storage area managed by the memory controller; and a read access section configured to, when the refill requests generated by the refill request generation section have been accumulated for a predetermined number of banks among the plurality of banks managed by the memory controller, perform a read access to the dynamic random access memory while combining the refill requests for the predetermined number of banks.

According to another embodiment of the present invention, there is provided a method for controlling an information processing apparatus. The apparatus includes: a dynamic random access memory that is composed of a plurality of storage elements and which requires a precharge operation of charging each of the storage elements for data storage; a memory controller that manages accesses to the dynamic random access memory on a bank basis, a storage area of the dynamic random access memory being divided into a plurality of banks; a cache memory that is connected to the memory controller via a bus and which caches data stored in the dynamic random access memory; and an information processing block that performs a read access to the dynamic random access memory via the cache memory. The method includes the steps, performed by the cache memory, of: generating a refill request for caching the data stored in the dynamic random access memory in response to occurrence of a cache miss for the read access performed by the information processing block, the refill request being targeted at one or more of the banks of the storage area of the dynamic random access memory managed by the memory controller; and when the refill requests generated have been accumulated for a predetermined number of banks among the plurality of banks managed by the memory controller, performing a read access to the dynamic random access memory while combining the refill requests for the predetermined number of banks.

According to the embodiments of the present invention, when the refill requests, which are generated in response to the occurrence of the cache miss for the read access performed by the information processing block, have been accumulated for the predetermined number of banks among the plurality of banks managed by the memory controller, the cache memory accesses the dynamic random access memory while combining those refill requests. Therefore, the frequency is increased with which a storage area in the dynamic random access memory which is managed by a certain bank is accessed without waiting until the precharge operation for a storage area in the dynamic random access memory managed by another bank is completed. Accordingly, the time during which the dynamic random access memory is incapable of data transfer because of the precharge operation is reduced, resulting in an improvement in the utilization ratio of the bandwidth of the dynamic random access memory.

### BRIEF DESCRIPTION OF THE DRAWINGS

FIG. 1 is a block diagram illustrating an overall structure of an image processing apparatus;

FIGS. 2A and 2B are diagrams illustrating reference image data managed according to a first embodiment of the present invention;

FIG. 3 is a block diagram illustrating the structure of a cache memory according to the first embodiment;

FIGS. 4A to 4D are diagrams for explaining an operation of the cache memory according to the first embodiment;

FIGS. 5A and 5B are timing diagrams for explaining data transfer by a system bus;

FIGS. 6A and 6B are diagrams for explaining a data reading process performed by a dynamic random access memory;

FIGS. 7A and 7B are diagrams for explaining a grid memory map structure and a staggered grid memory map structure;

FIGS. 8A and 8B are diagrams illustrating reference image data managed by using the staggered grid memory map structure;

FIGS. 9A to 9C are diagrams for explaining read access processes in exemplary applications using the grid memory map structure and the staggered grid memory map structure;

FIGS. 10A and 10B are diagrams illustrating the reference image data managed according to a second embodiment of the present invention;

FIG. 11 is a block diagram illustrating the structure of a cache memory according to the second embodiment;

FIGS. 12A to 12C are diagrams for explaining an operation of the cache memory according to the second embodiment;

FIGS. 13A and 13B are diagrams illustrating the reference image data managed according to a third embodiment of the present invention;

FIG. 14 is a block diagram illustrating the structure of a cache memory according to the third embodiment;

FIGS. 15A to 15D are diagrams for explaining an operation of the cache memory according to the third embodiment;

FIG. 16 is a block diagram illustrating the structure of a cache memory according to a fourth embodiment of the present invention; and

FIG. 17 is a timing diagram for explaining data transfer by the system bus.

### DETAILED DESCRIPTION OF THE PREFERRED EMBODIMENTS

Hereinafter, preferred embodiments of the present invention will be described in detail with reference to the accompanying drawings.

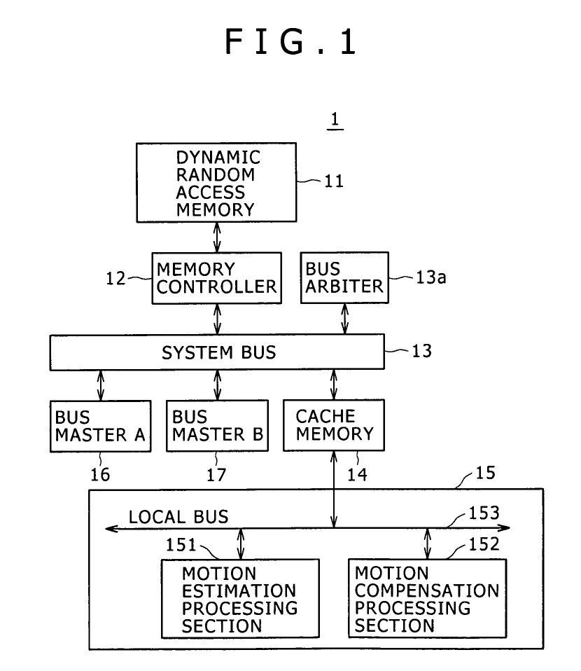

An information processing apparatus according to one embodiment of the present invention is an apparatus that includes an information processing block that accesses a dynamic random access memory via a cache memory. Specific examples of such information processing blocks include: a motion estimation processing block that concerns a process of encoding image data to reduce redundancy therein; and a motion compensation processing block that concerns a process of decoding the data encoded by the encoding process. FIG. 1 shows an image processing apparatus 1 that includes the motion estimation processing block and the motion compensation processing block.

As shown in FIG. 1, the image processing apparatus 1 includes: a dynamic random access memory 11 for storing the image data; a memory controller 12 for managing a storage area of the dynamic random access memory 11; a system bus 13; a cache memory 14 that is connected to the memory controller 12 via the system bus 13 and used to cache the data stored in the dynamic random access memory 11; and an image processing block 15 for performing a read access to the dynamic random access memory 11 via the cache memory 14. In addition, the image processing apparatus 1 includes two bus masters 16 and 17, which are connected to the memory controller 12 via the system bus 13 and which access the dynamic random access memory 11, for example.

The dynamic random access memory 11 is composed of a plurality of storage elements. As described below, the dynamic random access memory 11 is a randomly accessible memory that requires a precharge operation of charging each of the storage elements for data storage.

In the image processing apparatus 1, the dynamic random access memory 11 functions as a frame memory for a system for encoding the image data or a system for decoding the image data, and stores reference image data that is used by the image processing block 15. Note that the dynamic random access memory 11 may be provided with an area for storing a program, in addition to the reference image data.

The storage area of the dynamic random access memory 11 is divided into a plurality of banks. The memory controller 12 manages accesses to the dynamic random access memory 11 on a bank basis. In addition, the memory controller 12 stores the reference image data in storage areas of the dynamic random access memory 11 divided into the banks, as described below.

The memory controller 12, the cache memory 14, and the two bus masters 16 and 17 are connected to the system bus 13. The cache memory 14 and the two bus masters 16 and 17 are processing blocks that access the dynamic random access memory 11 via the memory controller 12. The system bus 13 transfers data for accesses between these processing blocks connected thereto. In addition, the system bus 13 is provided with a bus arbiter 13a that controls whether or not to permit any one of the processing blocks connected to the system bus 13 to access the dynamic random access memory 11, in order to prevent a conflict of accesses among the connected processing blocks.

The cache memory 14 is connected to the memory controller 12 via the system bus 13, and caches the reference image data stored in the dynamic random access memory 11. Specifically, the cache memory 14 is connected to the image processing block 15, and if a cache miss occurs when a read request has been made from the image processing block 15, the cache memory 14 generates a refill request. Then, in accordance with the generated refill request, the cache memory 14 performs a read access to the dynamic random access memory 11 to cache the reference image data.

Note that the cache memory 14 may be configured to perform both the read access and a write access to the dynamic random access memory 11, but may alternatively be configured only to read, from the dynamic random access memory 11, data for which a read access is made from the image processing block 15. Accordingly, the cache memory 14 may be a memory that is configured to function as a read-only cache, with simpler functionality and a reduced circuit scale of memory circuitry.

The image processing block 15 is a processing block that performs the read access to the dynamic random access memory 11 via the cache memory 14. The image processing block 15 includes: a motion estimation processing section 151 for performing a motion estimation process related to the encoding process; a motion compensation processing section 152 that is related to the decoding process of decoding the encoded image data; and a local bus 153 that connects the motion estimation processing section 151 and the motion compensation processing section 152 to the cache memory 14.

The motion estimation processing section 151 horizontally scans and selects current macroblocks to be encoded one after another. The motion estimation processing section 151 performs the read access to the dynamic random access memory 11 in order to acquire the reference image data to be used to estimate a motion vector for the current macroblocks as selected.

The motion compensation processing section 152 horizontally scans and selects current macroblocks to be decoded one after another. The motion compensation processing section 152 performs the read access to the dynamic random access memory 11 in accordance with the motion vector of the selected current macroblock in question to read the reference image data. Then, the motion compensation processing section 152 uses the read reference image data to perform motion compensation on the current macroblock.

Here, because each of the motion estimation processing section 151 and the motion compensation processing section 152 horizontally scans and selects the current macroblocks one after another, it is very likely that reference macroblocks are also horizontally scanned and selected.

Each of the motion estimation processing section 151 and the motion compensation processing section 152 supplies, to the cache memory 14 via the local bus 153, a read access request for reading desired reference image data. In addition, depending on this read access request, each of the motion estimation processing section 151 and the motion compensation processing section 152 supplies, to the cache memory 14, a non-combining notification signal for causing the cache memory 14 to perform the read access without combining the refill requests.

Because the refill request in accordance with the read access request is generated in the cache memory 14 as described below, each of the motion estimation processing section 151 and the motion compensation processing section 152 is capable of outputting the read request to the cache memory 14 without limitation on the order of addressing or a transfer length. Thus, each of the motion estimation processing section 151 and the motion compensation processing section 152 accomplishes simplification of address generation and reduction in circuit scale.

Each of the bus masters 16 and 17 is connected to the memory controller 12 via the system bus 13, and performs a write access to the dynamic random access memory 11 to write image data for the reference image data to the dynamic random access memory 11 or performs a read access to the dynamic random access memory 11 to read the image data from the dynamic random access memory 11 to output it. Note that the operation of each of the bus masters 16 and 17 is not limited to accessing to the image data. That is, in the case where the dynamic random access memory 11 stores the program in addition to the image data, each of the bus masters 16 and 17 may access the area in which the program is stored.

In the image processing apparatus 1 having the above-described structure, the memory controller 12 divides an image area of each picture of the reference image data into a plurality of units, further divides an image area of each unit into a plurality of subunits, and allocates data corresponding to each subunit to one or more of the banks of the storage area of the dynamic random access memory 11 to store the data in that bank(s).

Specifically, the memory controller 12 divides each unit into m parts horizontally and n parts vertically (m and n are both a positive integer), and allocates data corresponding to each of the resulting m×n subunits to one or more of the banks of the storage area of the dynamic random access memory 11 to store the data in that bank(s).

The structure and operation of the image processing apparatus 1, in which the dynamic random access memory 11 is managed with a memory map structure with specific values set in m and n, will be described below.

### First Embodiment

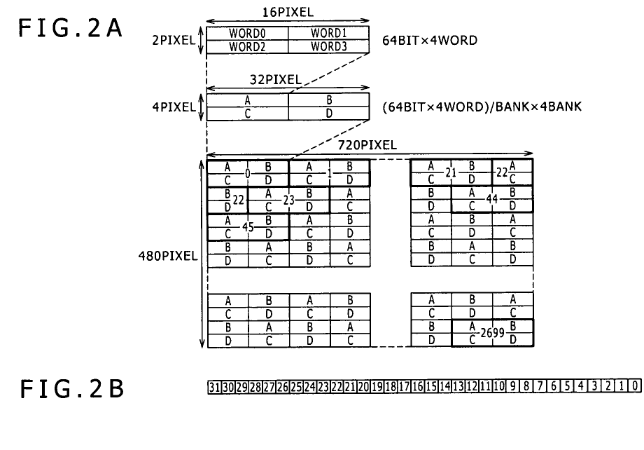

In the image processing apparatus 1 according to a first embodiment, the system bus 13 has a data width of 64 bits, and as shown in FIG. 2A, the memory controller 12 divides each picture, measuring 720 pixels horizontally and 480 pixels vertically, of the reference image data into regions, and manages them on the storage area of the dynamic random access memory 11.

As shown in FIG. 2A, the memory controller 12 divides each picture of the reference image data into 2700 units, each measuring 32 pixels horizontally and four pixels vertically. In FIG. 2A, the 2700 units are assigned numbers 0 to 2699.

Next, the memory controller 12 divides each unit into a total of four subunits, each measuring 16 pixels horizontally and two pixels vertically.

Next, the memory controller 12 allocates image data corresponding to each of the four subunits within each unit to one of four banks A, B, C, and D of the storage area of the dynamic random access memory 11 to store the image data in that bank. Specifically, the memory controller 12 allocates the banks A and B to an upper pair of subunits in each unit and the banks C and D to a lower pair of subunits in each unit, while in each column of units, the banks A and B reverse their sides (right and left) alternately and the banks C and D reverse their sides alternately. A memory map structure that allocates the data of each subunit to one of the banks in the above-described manner will be hereinafter referred to as a “staggered grid memory map structure.”

Still further, the memory controller 12 divides each subunit into four words, each measuring eight pixels horizontally and one pixel vertically, and manages them on a bank basis. Notice here that the data width of the word is 64 bits, corresponding to the data width of the system bus.

Still further, the memory controller 12 manages an address of each word by setting the address in a manner as shown in FIG. 2B. Specifically, the address of each word is 32 bits long, for example, and information indicating the bit length of 64 bits is allocated to 0th to 2nd bits, an address within the bank is allocated to 3rd and 4th bits, an address of one of the banks A, B, C, and D is allocated to 5th and 6th bits, and an address of the unit is allocated to 7th to 31st bits arbitrarily. More specifically, the address within the bank allocated to the 3rd and 4th bits indicates one of words 0 to 3. The address allocated to the 5th and 6th bits is in binary notation, and “00,” “01,” “10,” and “11” represent the banks A, B, C, and D, respectively.

The dynamic random access memory 11 is managed by the memory controller 12 in the above-described manner. When the refill requests have been accumulated for a predetermined number of banks among the plurality of banks managed by the memory controller 12, specifically, when the refill requests have been accumulated for the total of four banks A, B, C, and D, the cache memory 14 performs the read access to the dynamic random access memory 11 while combining these refill requests. By allowing the data to be cached in the above-described manner, the image processing apparatus 1 achieves a reduction in a time during which the dynamic random access memory 11 is incapable of data transfer and thereby achieves an improvement in the utilization ratio of the bandwidth of the dynamic random access memory 11, as described below.

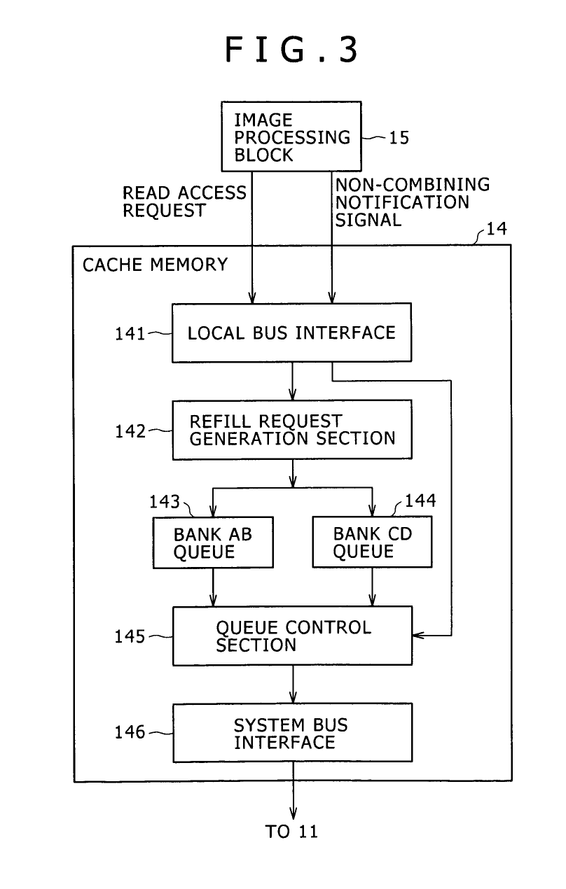

Referring to FIG. 3, in order to achieve the above-described read access to the dynamic random access memory 11, the cache memory 14 according to the first embodiment includes a local bus interface 141, a refill request generation section 142, a bank AB queue 143, a bank CD queue 144, a queue control section 145, and a system bus interface 146. The local bus interface 141 exchanges data with the local bus 153. If the cache miss occurs when the read access request has been made from the image processing block 15, the refill request generation section 142 generates the refill request for caching the data stored in the dynamic random access memory 11. The bank AB queue 143 stores a refill request for the banks A and B. The bank CD queue 144 stores a refill request for the banks C and D. The queue control section 145 controls output of the read access request in accordance with the refill request. The system bus interface 146 outputs the read access request to the system bus 13.

The local bus interface 141 receives, from the image processing block 15, the read access request for reading the desired reference image data, and the non-combining notification signal for initiating the read access to the dynamic random access memory 11 without combining the refill requests. Then, the local bus interface 141 supplies the read access request and the non-combining notification signal to the refill request generation section 142 and the queue control section 145, respectively.

If the cache miss occurs in response to the read access request, the refill request generation section 142 generates the refill request for caching the reference image data stored in the dynamic random access memory 11 for the storage area managed by the memory controller 12 on a bank basis.

That is, in response to the read access request, the refill request generation section 142 determines whether or not the cache miss has occurred on the basis of a data unit corresponding to a set of subunits that are horizontally or vertically adjacent to one another. If the cache miss has occurred, the refill request generation section 142 generates the refill request for a group of banks composed of a set of banks that manage data that has experienced the cache miss. Specifically, in response to the read access request, the refill request generation section 142 determines whether or not the cache miss has occurred on the basis of a data unit corresponding to a pair of subunits that are horizontally adjacent to each other. If the cache miss has occurred, the refill request generation section 142 generates the refill request for a group of banks composed of a total of two banks that manage data that has experienced the cache miss. Such a group of banks is not limited to banks that manage a pair of subunits that are horizontally adjacent to each other within the same unit, but may be banks that manage a pair of subunits that are horizontally adjacent to each other but which belong to different units.

Each of the bank AB queue 143 and the bank CD queue 144 is a refill request storage section configured to store the refill requests generated by the refill request generation section 142 while the refill requests are distributed between the bank AB queue 143 and the bank CD queue 144 according to the banks managed by the memory controller 12. Specifically, the bank AB queue 143 is a refill request storage section configured to store the refill request made for a group of banks composed of the pair of the banks A and B. Meanwhile, the bank CD queue 144 is a refill request storage section configured to store the refill request made for a group of banks composed of the pair of the banks C and D.

When the refill requests have been accumulated in the bank AB queue 143 and the bank CD queue 144 for all the banks, i.e., the banks A, B, C, and D, the queue control section 145 combines the refill requests made for these banks, and outputs, to the system bus interface 146, the read access request to the dynamic random access memory 11. That is, the queue control section 145 outputs, to the system bus interface 146, a read access request for combined read accesses to the banks A, B, C, and D.

Here, if the queue control section 145 receives the non-combining notification signal from the local bus interface 141, the queue control section 145 outputs the read access request to the system bus interface 146 without waiting until the refill requests are accumulated in the bank AB queue 143 and the bank CD queue 144 for all the banks, i.e., without combining the refill requests.

The system bus interface 146 acquires, from the bus arbiter 13a provided for the system bus 13, a right of using the bus to perform the read access to the memory controller 12 via the system bus 13.

Next, the operation of the cache memory 14, having the above-described structure, according to the first embodiment will now be described below.

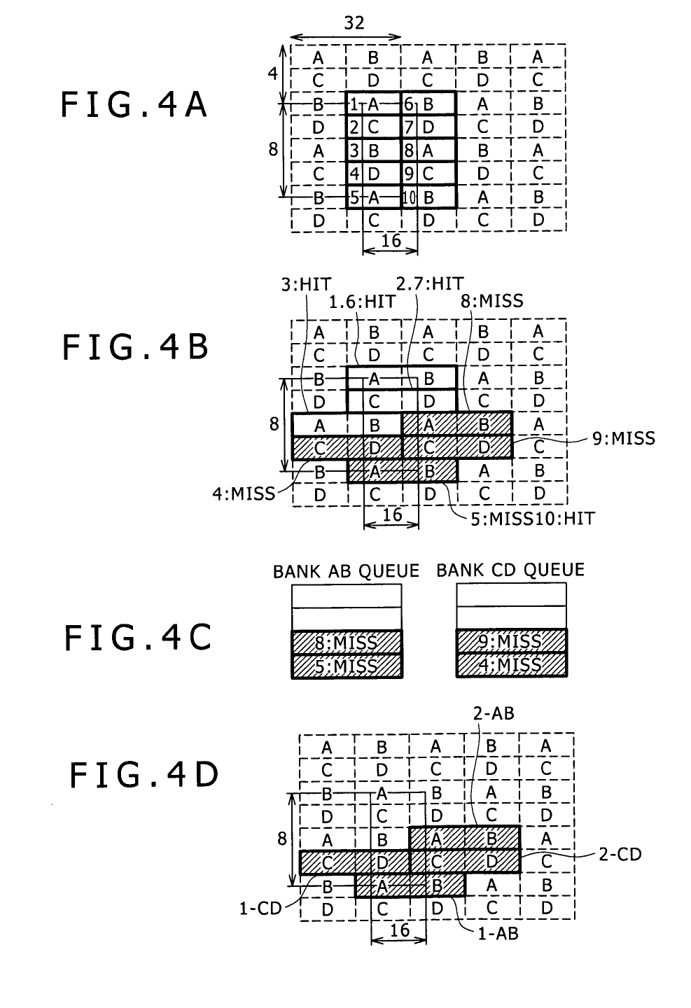

Referring to FIG. 4A, assume, for example, that the image processing block 15 makes read access requests for subunits 1 to 5, five of them being contiguously arranged vertically, and subunits 6 to 10, five of them being also contiguously arranged vertically, to the dynamic random access memory 11 via the cache memory 14, in order to acquire a reference macroblock measuring 16 pixels horizontally and eight pixels vertically.

Specifically, the read access requests are composed of requests for: a read access to the bank A, which manages data of subunit 1; a read access to the bank C, which manages data of subunit 2; a read access to the bank B, which manages data of subunit 3; a read access to the bank D, which manages data of subunit 4; a read access to the bank A, which manages data of subunit 5; a read access to the bank B, which manages data of subunit 6; a read access to the bank D, which manages data of subunit 7; a read access to the bank A, which manages data of subunit 8; a read access to the bank C, which manages data of subunit 9; and a read access to the bank B, which manages data of subunit 10.

The cache memory 14 determines whether or not the data corresponding to each of these read access requests are cached therein. Referring to FIG. 4B, suppose, for example, that the data corresponding to subunits 1, 2, 3, 6, and 7 experience a cache hit, while data corresponding to subunits 4, 5, 8, 9, and 10 experience the cache miss. In this case, the refill request generation section 142 generates: a refill request 4:Miss for a group of banks composed of the banks C and D that manage subunit 4 and a subunit adjacent to and to the left of subunit 4; a refill request 5:Miss for a group of banks composed of the banks A and B that manage subunit 5 and subunit 10, which is adjacent to and to the right of subunit 5; a refill request 8:Miss for a group of banks composed of the banks A and B that manage subunit 8 and a subunit that is adjacent to and to the right of subunit 8; and a refill request 9:Miss for a group of banks composed of the banks C and D that manage subunit 9 and a subunit that is adjacent to and to the right of subunit 9.

Next, referring to FIG. 4C, in the cache memory 14, the refill request 5:Miss and the refill request 8:Miss are stored in the bank AB queue 143 sequentially, and the refill request 4:Miss and the refill request 9:Miss are stored in the bank CD queue 144 sequentially.

Next, when the refill requests have been accumulated in the bank AB queue 143 and the bank CD queue 144 for all of the banks A, B, C, and D, the queue control section 145 of the cache memory 14 sequentially generates the read access request as appropriate. Specifically, referring to FIG. 4D, the cache memory 14 outputs a read access request 1-ABCD that combines the refill request 5:Miss and the refill request 4:Miss, and a read access request 2-ABCD that combines the refill request 8:Miss and the refill request 9:Miss sequentially. Note that if the queue control section 145 receives the non-combining notification signal from the local bus interface 141, the queue control section 145 outputs the read access request in accordance with the refill requests stored in the bank AB queue 143 and the bank CD queue 144, without performing the above combining process.

As described above, the cache memory 14 accesses the dynamic random access memory 11 via the system bus 13 while combining the read access requests for all of the four banks A, B, C, and D. Because the access to each bank is to four words, i.e., a burst length of 4, the cache memory 14 makes an access with a burst length of 16 at a time to the dynamic random access memory 11.

Here, in the case where the bus arbiter 13a provided for the system bus 13 grants the right of using the bus to the cache memory 14 and the two bus masters 16 and 17 with one transaction having a burst length of 8, for example, the bus arbiter 13a needs to permit the cache memory 14 an access with a burst length of 16, i.e., the combination of two accesses each having a burst length of 8.

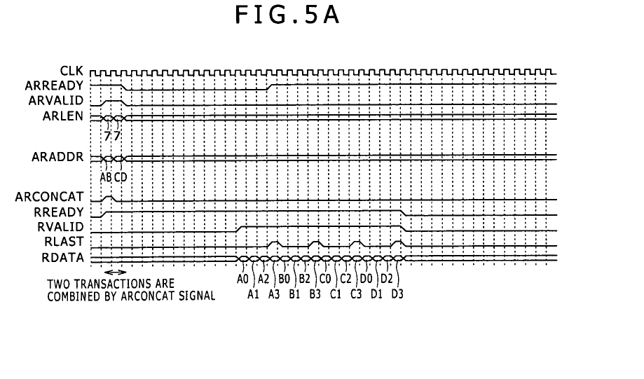

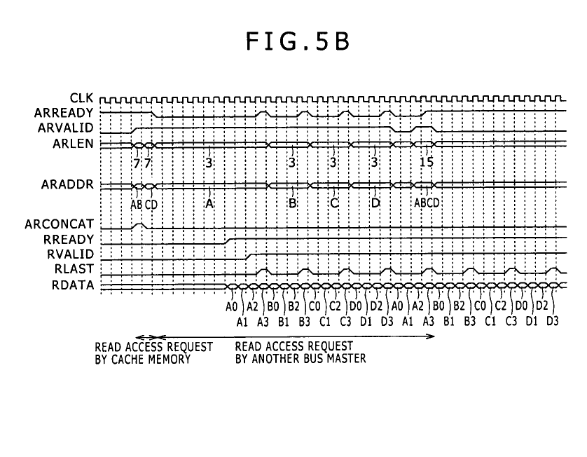

Accordingly, as shown in FIG. 5A, in access control using the system bus 13, a signal ARCONCAT for permitting combined accesses, in addition to signals that are used in common bus transfer, is used to grant the right of using the system bus 13.

FIG. 5A is a timing diagram concerning a process of read access between the cache memory 14 and the system bus 13. FIG. 5B is a timing diagram concerning a process of read access between the system bus 13 and the dynamic random access memory 11.

In FIGS. 5A and 5B, signals ARREADY, ARVALID, ARLEN, ARADDR, RREADY, RVALID, RLAST, and RDATA are signals used in common bus transfer.

Specifically, the signal ARREADY is a signal used to indicate that a preparation for one read transaction in accordance with the read access request has been completed, when it is HIGH. The signal ARVALID is a signal used to indicate that the read access is valid, when it is HIGH. The signal ARLEN is a signal used to indicate the burst length of each transaction of read access. The signal ARADDR is a signal used to indicate read addresses, specifically addresses of the banks A, B, C, and D. The signal RREADY is a signal used to indicate that a preparation for the read access has been completed, when it is HIGH. The signal RVALID is a signal used to indicate that the read access is valid, when it is HIGH. The signal RLAST is a signal used to indicate that each transaction of read access has been completed, when it is HIGH. The signal RDATA is a signal used to indicate read data.

The signal ARCONCAT is a signal that indicates combination information for combining read accesses for a range of read addresses starting with a read address corresponding to a Low to HIGH transition and ending with a first read address after a HIGH to Low transition.

As shown in FIG. 5A, the cache memory 14 supplies, to the bus arbiter 13a, the signal ARCONCAT as combination information for combining a transaction of a refill request for both the banks A and B and a transaction of a refill request for both the banks C and D. Meanwhile, in accordance with the signal ARCONCAT, the bus arbiter 13a permits the cache memory 14 to make an access with a single read access request while combining the two refill requests. Thus, even when the two bus masters 16 and 17 have made the read access request to the dynamic random access memory 11 via the system bus 13, it is possible to read the pieces of data in accordance with the read access request from the cache memory 14 continuously from the dynamic random access memory 11 and supply the read data continuously to the cache memory 14 as shown in FIG. 5B, for example.

Also, in the case where the two bus masters 16 and 17 make a read access request with a burst length of less than 16 at a time to the dynamic random access memory 11, the bus masters 16 and 17 output the signal ARCONCAT to combine transactions, acquire the right of using the bus, and perform a read access with a burst length of 16 at a time to the dynamic random access memory 11, as is the case with the above-described processing of the cache memory 14.

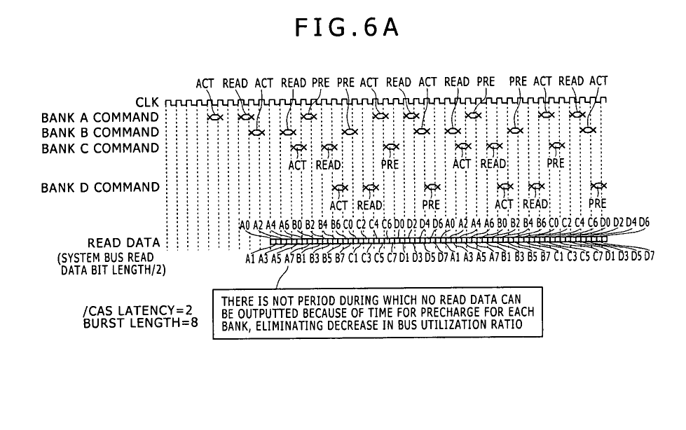

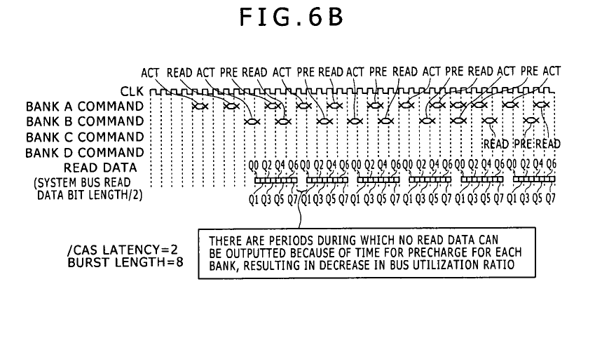

As described above, in the dynamic random access memory 11, to which the read access requests for the banks A, B, C, and D are continuously supplied from the cache memory 14 and the bus masters 16 and 17, the data are read from the storage area managed by the memory controller 12 on the basis of the banks A, B, C, and D, as illustrated in FIG. 6A.

FIG. 6A is a timing diagram of read processes performed in response to the read access request for each of the banks A, B, C, and D. In FIG. 6A, a command ACT is a command for specifying an address data line within the storage area, a command READ is a command for reading data from the data line specified by the command ACT, and a command PRE is a command for performing a precharge operation of charging storage elements arranged on the data line in order to hold the data read by the command READ.

Accordingly, the memory controller 12 issues the commands ACT, READ, and PRE in this order for each of the banks A, B, C, and D to read the data from the respective storage areas managed thereby.

Here, referring to FIG. 6B, suppose that a process of reading data from the storage areas of the banks A and B alternately is performed. In this case, even if command intervals between the commands ACT, READ, and PRE are reduced to a minimum for each bank, a period occurs during which no read data can be outputted to the system bus 13.

In contrast, the memory controller 12 performs the read accesses to the banks A, B, C, and D continuously. Therefore, as shown in FIG. 6A, the frequency can be increased with which a storage area in the dynamic random access memory which is managed by a certain bank is accessed without waiting until the precharge operation for a storage area managed by another bank is completed. Thus, the memory controller 12 is capable of allowing the read data to be outputted from the dynamic random access memory 11 continuously regardless of the precharge operations.

As described above, when the refill requests, i.e., the read access requests, have been accumulated for all of the four banks A, B, C, and D, the cache memory 14 in the image processing apparatus 1 performs the read access to the dynamic random access memory 11 while combining these read access requests. Thus, as shown in FIG. 6A, for example, the read data can be transferred from the dynamic random access memory 11 to the cache memory 14 via the system bus 13 continuously. As a result, the utilization ratio of the bandwidth of the dynamic random access memory 11 is improved.

Note that the time during which the dynamic random access memory 11 is incapable of data transfer can be reduced even in the case where the cache memory 14, when the read access requests have been accumulated not for all of the four banks managed by the memory controller 12 but for two or three of the four banks, accesses the dynamic random access memory 11 while combining the read access requests for the two or three banks. This is because, even if the read data cannot be outputted continuously, the read access requests for the two or three banks are made continuously, and accordingly the frequency is increased with which a storage area in the dynamic random access memory which is managed by a certain bank is read/accessed without waiting until the precharge operation for a storage area managed by another bank is completed.

In the first embodiment, the reference image data is managed by using the staggered grid memory map structure. That is, the memory controller 12 allocates the banks A and B to the upper pair of subunits in each unit and the banks C and D to the lower pair of subunits in each unit, while in each column of units, the banks A and B reverse their sides (right and left) alternately and the banks C and D reverse their sides alternately. Note that this staggered grid memory map structure is not essential to the present invention. For example, it may be so arranged that each unit is divided into two parts both horizontally and vertically to obtain a total of four subunits, and that the memory controller 12 allocates data of the upper right subunit, data of the upper left subunit, data of the lower right subunit, and data of the lower left subunit in each unit to the bank A, the bank B, the bank C, and the bank D, respectively, so that these pieces of data will be stored in the corresponding banks thereof. A memory map structure that allocates the data of each subunit to the corresponding bank in the above-described manner will be hereinafter referred to as a “grid memory map structure.” In the case where reference macroblocks each measuring 16 pixels horizontally and 16 pixels vertically, for example, are horizontally scanned and selected one after another in the reference image data having the grid memory map structure, subunits that may experience the cache miss are selected as follows.

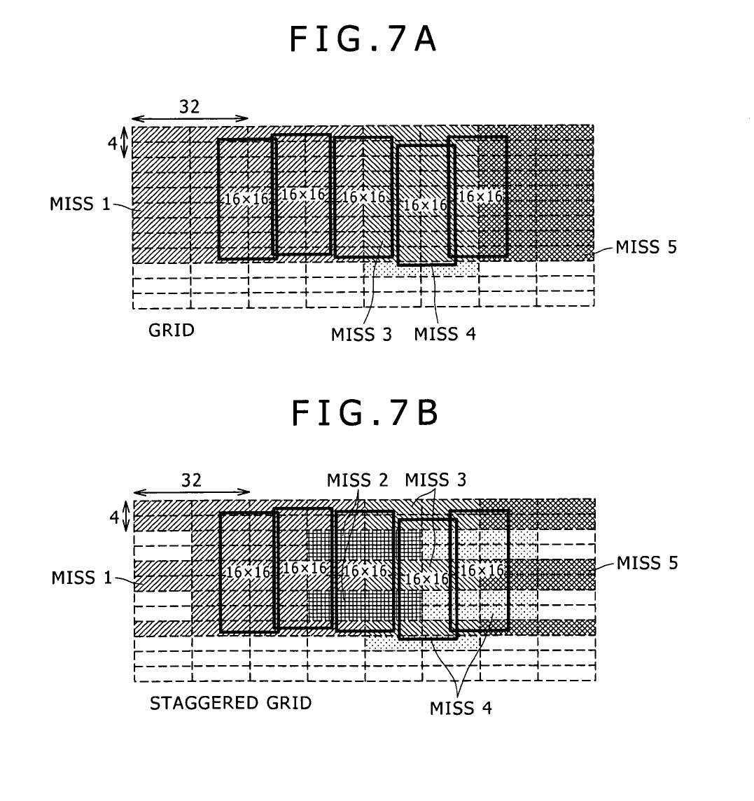

In FIG. 7A, area Miss1 indicates an image area that may experience the cache miss in connection with a read request for a reference macroblock that is selected first. Area Miss3 indicates an image area that may experience the cache miss in connection with a read request for a reference macroblock that is selected third. Area Miss4 indicates an image area that may experience the cache miss in connection with a read request for a reference macroblock that is selected fourth. Area Miss5 indicates an image area that may experience the cache miss in connection with a read request for a reference macroblock that is selected fifth.

As shown in FIG. 7A, in the case of the grid memory map structure, the amount of data for which the read access is made via the system bus 13 because of the occurrence of the cache miss varies greatly between different reference macroblocks that are horizontally scanned and may be selected.

In contrast, in the case where the memory controller 12 manages the reference image data by using the staggered grid memory map structure as shown in FIG. 7B, the amount of data for which the read access is made via the system bus 13 because of the occurrence of the cache miss is equalized among different reference macroblocks that are horizontally scanned and may be selected.

In FIG. 7B, area Miss1 indicates an image area that may experience the cache miss in connection with a read request for a reference macroblock that is selected first. Area Miss2 indicates an image area that may experience the cache miss in connection with a read request for a reference macroblock that is selected second. Area Miss3 indicates an image area that may experience the cache miss in connection with a read request for a reference macroblock that is selected third. Area Miss4 indicates an image area that may experience the cache miss in connection with a read request for a reference macroblock that is selected fourth. Area Miss5 indicates an image area that may experience the cache miss in connection with a read request for a reference macroblock that is selected fifth.

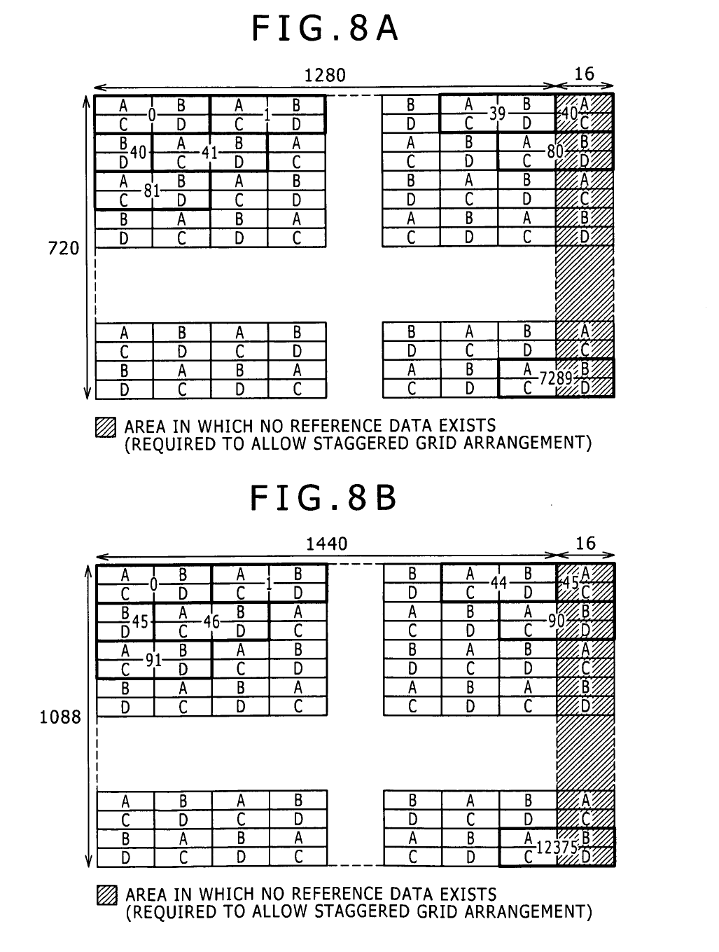

Here, the staggered grid memory map structure refers to the structure of a memory map in which data corresponding to a pair of subunits horizontally adjacent to each other in each unit are allocated to a pair of banks such that the subunits in each pair of the subunits reverse their sides alternately in each column of units. As described above, the memory controller 12 allocates the banks A and B to the upper pair of subunits in each unit and the banks C and D to the lower pair of subunits in each unit, while in each column of units, the banks A and B reverse their sides (right and left) alternately and the banks C and D reverse their sides alternately. In this manner, the memory controller 12 manages the reference image data by using the staggered grid memory map structure as shown in FIGS. 8A and 8B.

FIG. 8A illustrates an example of reference image data with a picture size measuring 1280 pixels horizontally and 720 pixels vertically which is managed by using the staggered grid memory map structure. Note that, in FIG. 8A, a diagonally shaded area with a size measuring 16 pixels horizontally and 720 pixels vertically is an area in which no reference image data exists. This area is required to allow the staggered grid memory map structure.

FIG. 8B illustrates an example of reference image data with a picture size measuring 1440 pixels horizontally and 1088 pixels vertically which is managed by using the staggered grid memory map structure. Note that, in FIG. 8B, a diagonally shaded area with a size measuring 16 pixels horizontally and 1088 pixels vertically is an area in which no reference image data exists. This area is required to allow the staggered grid memory map structure.

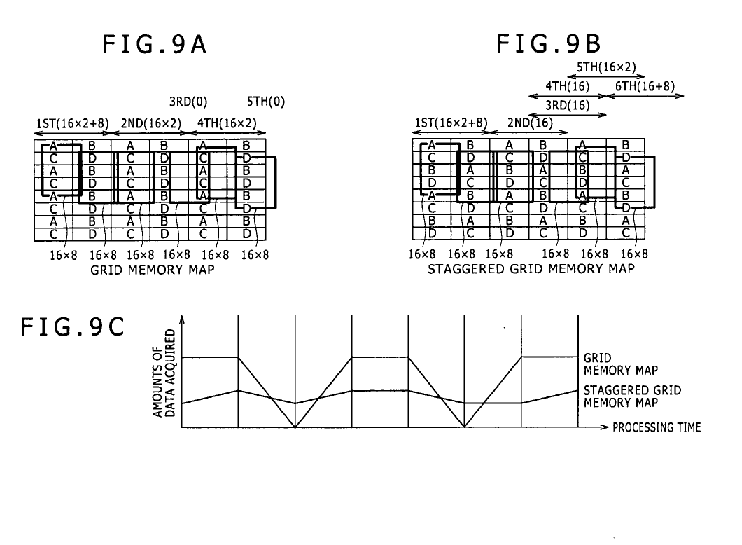

Next, with reference to FIGS. 9A, 9B, and 9C, exemplary applications using the grid memory map structure and the staggered grid memory map structure will now be described below.

FIG. 9A shows a specific example in which the reference image data is managed by using the grid memory map structure and reference macroblocks each measuring 16 pixels horizontally and eight pixels vertically are horizontally scanned and selected. Here, because the number of pixels horizontally arranged in each unit is 32, which is twice the number of pixels horizontally arranged in each reference macroblock, the amounts of data acquired in connection with reference macroblocks that are horizontally scanned and selected first, second, third, fourth, and fifth are 40 words (first), 32 words (second), 0 words (third), 32 words (fourth), and 0 words (fifth), respectively.

In contrast, FIG. 9B shows a specific example in which the reference image data is managed by using the staggered grid memory map structure and reference macroblocks each measuring 16 pixels horizontally and eight pixels vertically are horizontally scanned and selected. Here, because the number of pixels horizontally arranged in each unit is 32, which is twice the number of pixels horizontally arranged in each reference macroblock, the amounts of data acquired in connection with reference macroblocks that are horizontally scanned and selected first, second, third, fourth, fifth, and sixth are 40 words (first), 16 words (second), 16 words (third), 16 words (fourth), 32 words (fifth), and 24 words (sixth), respectively.

FIG. 9C is a graph that compares the above two specific examples, which use the grid memory map structure and the staggered grid memory map structure, respectively. In this graph, the horizontal axis represents the numbers of the reference macroblocks, while the vertical axis represents the amounts of data acquired. It is apparent from this graph that the amounts of data acquired per unit time are better equalized when using the staggered grid memory map structure than when using the grid memory map structure.

Thus, the memory controller 12 is capable of equalizing the amounts of data acquired per unit time by setting the number of pixels horizontally arranged in each unit at approximately twice the number of pixels horizontally arranged in each reference macroblock, and allocating data corresponding to a pair of subunits horizontally adjacent to each other to a pair of banks such that the subunits in each pair of the subunits reverse their sides alternately in each column of units.

### Second Embodiment

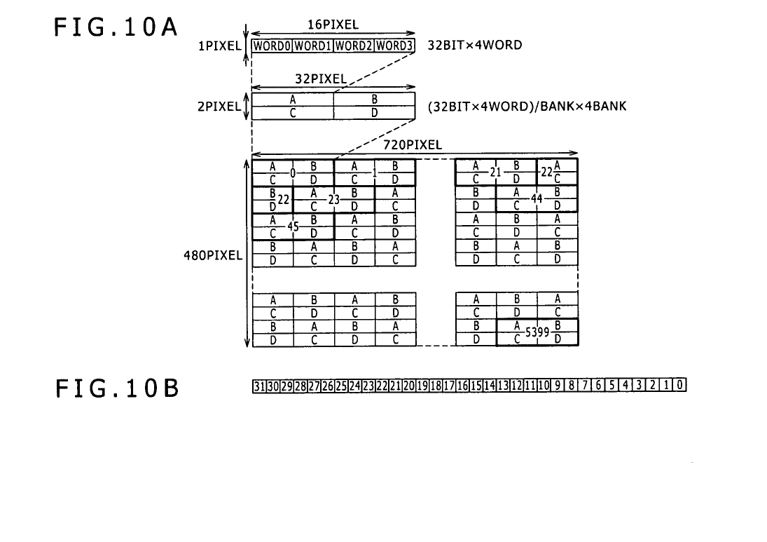

Next, in an image processing apparatus 1 according to a second embodiment of the present invention, the data width of the system bus 13 is 32 bits, for example, and as shown in FIG. 10A, the memory controller 12 divides each picture of reference image data with a picture size measuring 720 pixels horizontally and 480 pixels vertically into regions and manages them on the storage area of the dynamic random access memory 11.

As shown in FIG. 10A, the memory controller 12 divides each picture of the reference image data into a total of 5400 units, each measuring 32 pixels horizontally and two pixels vertically. In FIG. 10A, the 5400 units are assigned numbers 0 to 5399.

Next, the memory controller 12 divides each unit into a total of four subunits, each measuring 16 pixels horizontally and one pixel vertically.

Next, the memory controller 12 allocates image data corresponding to each of the four subunits within each unit to one of the four banks A, B, C, and D of the storage area of the dynamic random access memory 11 to store the image data in that bank. Specifically, the memory controller 12 allocates the data of each of the four subunits, which are obtained by dividing each unit into two parts both horizontally and vertically, to one of the banks A, B, C, and D in accordance with the above-described staggered grid memory map structure to store the data of each subunit in the corresponding bank.

In addition, the memory controller 12 divides each subunit into four words, each measuring four pixels horizontally and one pixel vertically, and manages them on a bank basis. Notice here that the data width of the word is 32 bits, corresponding to the data width of the system bus.

Still further, the memory controller 12 manages the address of each word by setting the address in a manner as shown in FIG. 10B. Specifically, the address of each word is 32 bits long, for example, and information indicating the bit length of 32 bits is allocated to 0th and 1st bits, an address within the bank is allocated to 2nd and 3rd bits, an address of one of the banks A, B, C, and D is allocated to 4th and 5th bits, and an address of the unit is allocated to 6th to 31st bits arbitrarily. More specifically, the address within the bank allocated to the 2nd and 3rd bits indicates one of words 0 to 3. The address allocated to the 4th and 5th bits is in binary notation, and “00,” “01,” “10,” and “11” represent the banks A, B, C, and D, respectively.

The dynamic random access memory 11 is managed by the memory controller 12 in the above-described manner. When the read access requests have been accumulated for a predetermined number of banks among the plurality of banks managed by the memory controller 12, specifically, when the read access requests have been accumulated for the total of four banks A, B, C, and D, the cache memory 14 accesses dynamic random access memory 11 to cache the data. Thus, the time during which the dynamic random access memory 11 is incapable of the data transfer is reduced, and the utilization ratio of the bandwidth of the dynamic random access memory 11 is improved.

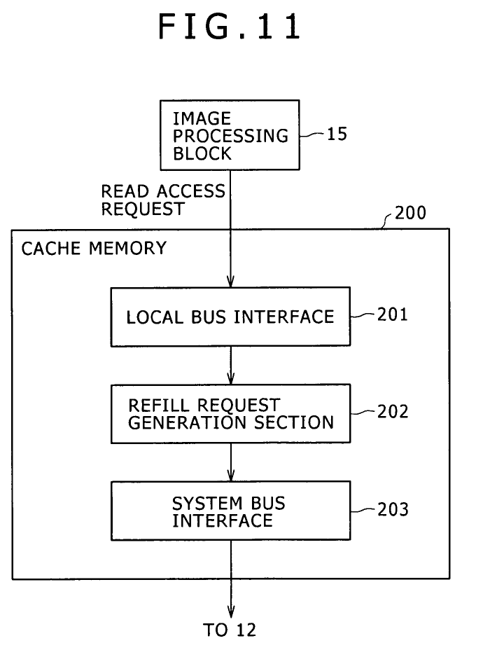

Referring to FIG. 11, in order to achieve such access to the dynamic random access memory 11, a cache memory 200 according to the second embodiment of the present invention includes a local bus interface 201, a refill request generation section 202, and a system bus interface 203. The local bus interface 201 exchanges the data with the local bus 153. The refill request generation section 202 generates the refill request for caching the data stored in the dynamic random access memory 11 in response to the occurrence of the cache miss for the read access request made by the image processing block 15. The system bus interface 203 controls output of the read access request in accordance with the refill request, and outputs the read access request to the system bus 13.

The local bus interface 201 receives, from the image processing block 15, the read request for reading the desired reference image data. Then, the local bus interface 201 supplies the read access request to the refill request generation section 202.

If the cache miss occurs in response to the read request, the refill request generation section 202 generates the refill request for caching the reference image data stored in the dynamic random access memory 11 for the storage area managed by the memory controller 12 on a bank basis. Specifically, the refill request generation section 202 determines whether the cache miss has occurred on the basis of a data unit corresponding to the subunit. If the cache miss has occurred, the refill request generation section 202 generates the refill request for banks A, B, C, and D that manage data corresponding to the subunit that has experienced the cache miss and subunits that are adjacent to this subunit.

The system bus interface 203 performs control of outputting the read access request in accordance with the refill request generated by the refill request generation section 202, and outputs the read access request to the system bus 13. The system bus interface 203 acquires the right of using the system bus 13 from the bus arbiter 13a provided for the system bus 13 to perform the read access to the memory controller 12 via the system bus 13.

Next, an operation of the cache memory 200, having the above structure, according to the second embodiment will now be described below.

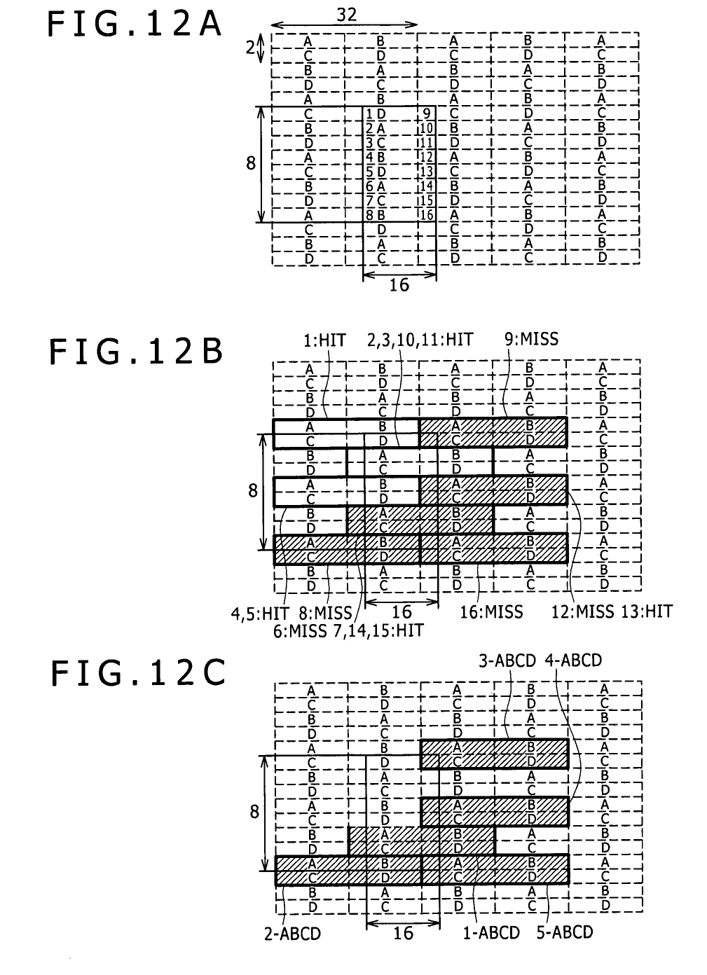

Referring to FIG. 12A, assume, for example, that in order to acquire a reference macroblock measuring 16 pixels horizontally and eight pixels vertically, the image processing block 15 makes, to the dynamic random access memory 11 via the cache memory 200, the read access requests for subunits 1 to 8, which are contiguously arranged vertically, and subunits 9 to 16, which are also contiguously arranged vertically.

Specifically, the read access requests are composed of requests for: a read access to the bank D, which manages data of subunit 1; a read access to the bank A, which manages data of subunit 2; a read access to the bank C, which manages data of subunit 3; a read access to the bank B, which manages data of subunit 4; a read access to the bank D, which manages data of subunit 5; a read access to the bank A, which manages data of subunit 6; a read access to the bank C, which manages data of subunit 7; a read access to the bank B, which manages data of subunit 8; a read access to the bank C, which manages data of subunit 9; a read access to the bank B, which manages data of subunit 10; a read access to the bank D, which manages data of subunit 11; a read access to the bank A, which manages data of subunit 12; a read access to the bank C, which manages data of subunit 13; a read access to the bank B, which manages data of subunit 14; a read access to the bank D, which manages data of subunit 15; and a read access to the bank A, which manages data of subunit 16.

The cache memory 200 determines whether the data corresponding to each of these read access requests are cached therein. Referring to FIG. 12B, suppose, for example, that data corresponding to subunits 1, 2, 3, 4, 5, 7, 10, 11, 13, 14, and 15 experience the cache hit, while data corresponding to subunits 6, 8, 9, 12, and 16 experience the cache miss. In this case, the refill request generation section 202 generates: a refill request 6:Miss for banks A, B, C, and D that manage subunit 6 and subunits 7, 14, and 15, which are adjacent to subunit 6; a refill request 8:Miss for banks A, B, C, and D that manage subunit 8 and subunits that are adjacent to subunit 8, specifically, a subunit that is to the left of subunit 8, a subunit that is to the lower left of subunit 8, and a subunit that is below subunit 8; a refill request 9:Miss for banks A, B, C, and D that manage subunit 9 and subunits that are adjacent to subunit 9, specifically, a subunit that is to the right of subunit 9, a subunit that is to the upper right of subunit 9, and a subunit that is above subunit 9; a refill request 12:Miss for banks A, B, C, and D that manage subunit 12 and subunits that are adjacent to subunit 12, specifically, a subunit that is to the right of subunit 12, a subunit that is to the lower right of subunit 12, and a subunit that is below subunit 12; and a refill request 16:Miss for banks A, B, C, and D that manage subunit 16 and subunits that are adjacent to subunit 16, specifically, a subunit that is to the right of subunit 16, a subunit that is to the lower right of subunit 16, and a subunit that is below subunit 16.

Next, as shown in FIG. 12C, the system bus interface 203 in the cache memory 200 outputs the refill requests 6:Miss, 8:Miss, 9:Miss, 12:Miss, and 16:Miss, each of which is made for all the banks A, B, C, and D, sequentially as read access requests 1-ABCD, 2-ABCD, 3-ABCD, 4-ABCD, and 5-ABCD, respectively.

Because each refill request generated by the refill request generation section 202 corresponds to a read access request targeted at all of the four banks A, B, C, and D, the system bus interface 203 in the cache memory 200 performs the read access to the dynamic random access memory 11 via the system bus 13 to cache the data.

In contrast to the cache memory 14 according to the first embodiment, the cache memory 200 acquires the right of using the bus without outputting the signal ARCONCAT. This is because one transaction of access to the banks A, B, C, and D has a burst length of 16, allowing the data to be outputted continuously, and there is not a need to combine a plurality of transactions.

As described above, in the image processing apparatus 1, the cache memory 200 performs the read access while combining the read access requests for the total of four banks A, B, C, and D. Accordingly, as in the above-described first embodiment, the pieces of read data can be outputted continuously from the dynamic random access memory 11 to the cache memory 200 via the system bus 13. Thus, the utilization ratio of the bandwidth of the dynamic random access memory 11 is improved.

Note here that, in the cache memory 200 according to the second embodiment, the refill request generation section 202 generates the refill request for the banks A, B, C, and D that manage the pieces of data corresponding to the subunit that has experienced the cache miss and the subunits adjacent to this subunit, and that therefore the frequency with which image data of subunits that need not be read are read is higher than in the first embodiment. However, because the cache memory 200 according to the second embodiment does not need to be provided with the refill request storage section for storing the refill requests, the utilization ratio of the bandwidth of the dynamic random access memory 11 can be improved with a reduced increase in circuit scale.

### Third Embodiment

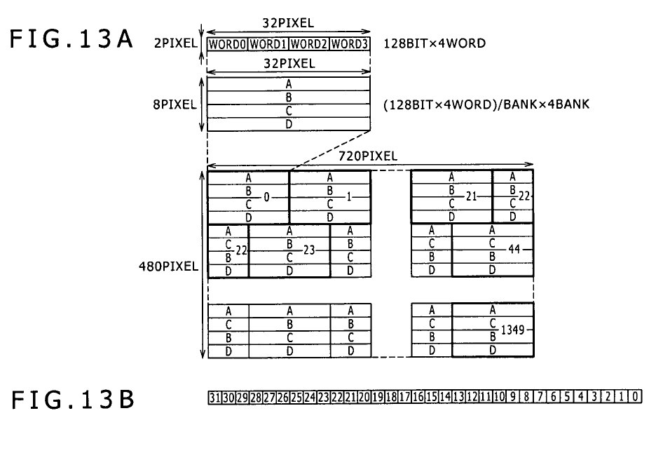

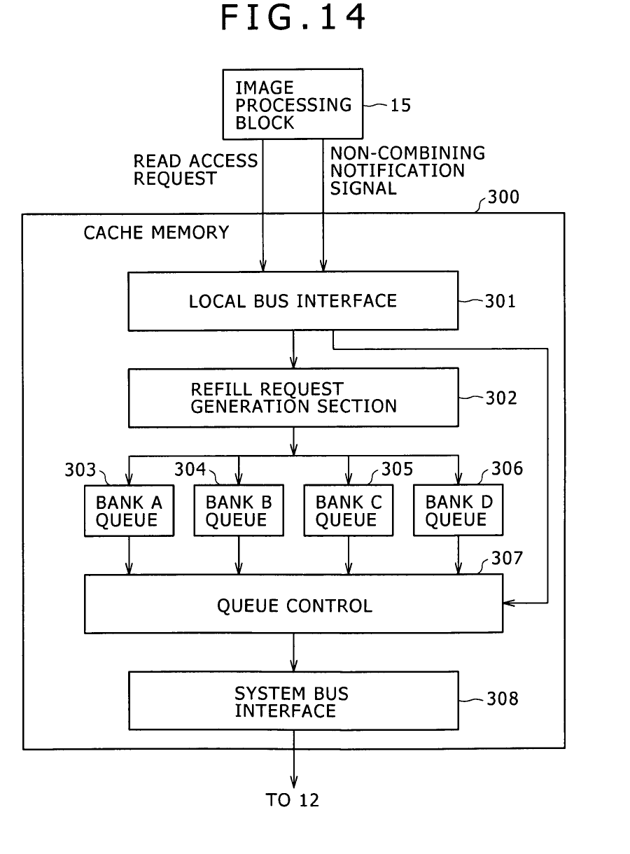

Next, in an image processing apparatus 1 according to a third embodiment of the present invention, the data width of the system bus 13 is 128 bits, for example, and as shown in FIG. 13A, the memory controller 12 divides each picture of the reference image data with a picture size measuring 720 pixels horizontally and 480 pixels vertically into regions and manages them on the storage area of the dynamic random access memory 11.

As shown in FIG. 13A, the memory controller 12 divides each picture of the reference image data into a total of 1350 units, each measuring 32 pixels horizontally and eight pixels vertically. In FIG. 13A, the 1350 units are assigned numbers 0 to 1349.

Next, the memory controller 12 divides each unit into a total of four subunits, each measuring 32 pixels horizontally and two pixels vertically.

Next, the memory controller 12 allocates image data corresponding to each of the four subunits within each unit to one of the four banks A, B, C, and D of the storage area of the dynamic random access memory 11 to store the image data in that bank. Specifically, the memory controller 12 allocates the data of each of the four subunits, which are obtained by dividing each unit into four parts vertically, to one of the banks A, B, C, and D such that the data of the top subunit, the data of the second top subunit, the data of the third top subunit, and the data of the bottom subunit in each unit are allocated to the banks A, B, C, and D, respectively, to store the data of each subunit in the corresponding bank.

In addition, the memory controller 12 divides each subunit into four words, each measuring eight pixels horizontally and two pixels vertically, and manages them on a bank basis. Notice here that the data width of the word is 128 bits, corresponding to the data width of the system bus.

Still further, the memory controller 12 manages the address of each word by setting the address in a manner as shown in FIG. 13B. Specifically, the address of each word is 32 bits long, for example, and information indicating the bit length of 128 bits is allocated to 0th to 3rd bits, an address within the bank is allocated to 4th and 5th bits, an address of one of the banks A, B, C, and D is allocated to 6th and 7th bits, and an address of the unit is allocated to 8th to 31st bits arbitrarily. More specifically, the address within the bank allocated to the 4th and 5th bits indicates one of words 0 to 3. The address allocated to the 6th and 7th bits is in binary notation, and “00,” “01,” “10,” and “11” represent the banks A, B, C, and D, respectively.

The dynamic random access memory 11 is managed by the memory controller 12 in the above-described manner. When the read access requests have been accumulated for a predetermined number of banks among the plurality of banks managed by the memory controller 12, specifically, when the read access requests have been accumulated for the total of four banks A, B, C, and D, a cache memory 300 according to the third embodiment performs the read access to the dynamic random access memory 11 while combining these refill requests. By allowing the data to be cached in the above-described manner, the image processing apparatus 1 achieves a reduction in the time during which the dynamic random access memory 11 is incapable of the data transfer and thereby achieves an improvement in the utilization ratio of the bandwidth of the dynamic random access memory 11, as described below.

Referring to FIG. 14, in order to achieve such access to the dynamic random access memory 11, the cache memory 300 according to the third embodiment includes a local bus interface 301, a refill request generation section 302, a bank A queue 303, two bank B queues 304, a bank C queue 305, a bank D queue 306, a queue control section 307, and a system bus interface 308. The local bus interface 301 exchanges the data with the local bus 153. The refill request generation section 302 generates the refill request for caching the data stored in the dynamic random access memory 11 in response to the occurrence of the cache miss for the read access request made by the image processing block 15. The bank A queue 303 stores the refill request for the bank A. The bank B queue 304 stores the refill request for the bank B. The bank C queue 305 stores the refill request for the bank C. The bank D queue 306 stores the refill request for the bank D. The queue control section 307 controls the output of the read access request in accordance with the refill request. The system bus interface 308 outputs the read access request to the system bus 13.

The local bus interface 301 receives, from the image processing block 15, the read request for reading the desired reference image data and the non-combining notification signal for initiating the read access without combining the refill requests. Then, the local bus interface 301 supplies the read request to the refill request generation section 302, and the non-combining notification signal to the queue control section 307.

If the cache miss occurs in response to the read request, the refill request generation section 302 generates the refill request for caching the reference image data stored in the dynamic random access memory 11 for the storage area managed by the memory controller 12 on a bank basis. Specifically, if the read request is made from the image processing block 15, the refill request generation section 302 determines whether or not the cache miss has occurred on the basis of the data unit corresponding to the subunit. If the cache miss has occurred, the refill request generation section 302 generates the refill request for the bank that manages data that has experienced the cache miss.

Each of the bank A queue 303, the bank B queue 304, the bank C queue 305, and the bank D queue 306 is a refill request storage section for storing the refill requests generated by the refill request generation section 302 while the refill requests are distributed therebetween according to the banks managed by the memory controller 12. Specifically, the bank A queue 303 is a refill request storage section configured to store the refill request for the bank A. The bank B queue 304 is a refill request storage section configured to store the refill request for the bank B. The bank C queue 305 is a refill request storage section configured to store the refill request for the bank C. The bank D queue 306 is a refill request storage section configured to store the refill request for the bank D.

When the refill request has been stored in each of the bank A queue 303, the bank B queue 304, the bank C queue 305, and the bank D queue 306, i.e., when the refill requests have been accumulated for all the banks, the queue control section 307 combines those refill requests for the banks and outputs the read access request for the dynamic random access memory 11 to the system bus interface 308. That is, the queue control section 307 outputs a read access request that combines the read accesses to all the banks A, B, C, and D to the system bus interface 308.

Here, when the non-combining notification signal has been supplied from the local bus interface 301, the queue control section 307 outputs the read access request to the system bus interface 308 without combining the refill requests, before the refill request is stored in each of the bank A queue 303, the bank B queue 304, the bank C queue 305, and the bank D queue 306.

The system bus interface 308 acquires the right of using the bus from the bus arbiter 13a provided for the system bus 13, and performs the read access to the memory controller 12 via the system bus 13.

Next, the operation of the cache memory 300, having the above-described structure, according to the third embodiment will now be described below.

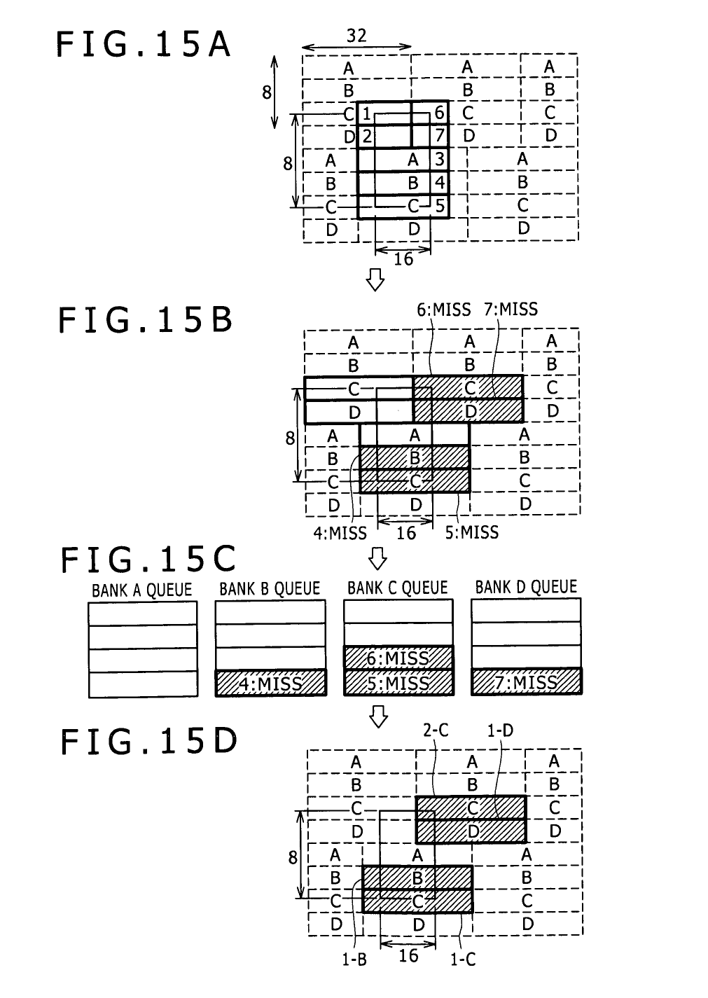

Referring to FIG. 15A, assume, for example, that in order to acquire a reference macroblock measuring 16 pixels horizontally and eight pixels vertically, the image processing block 15 makes, to the dynamic random access memory 11 via the cache memory 300, the read requests for a total of seven subunits 1 to 7.

Specifically, the read requests are composed of requests for: a read access to the bank C, which manages data of subunit 1; a read access to the bank D, which manages data of subunit 2; a read access to the bank A, which manages data of subunit 3; a read access to the bank B, which manages data of subunit 4; a read access to the bank C, which manages data of subunit 5; a read access to the bank C, which manages data of subunit 6; and a read access to the bank D, which manages data of subunit 7.

The cache memory 300 determines whether the data corresponding to each of these read access requests is cached therein. Referring to FIG. 15B, suppose, for example, that the data corresponding to subunits 1, 2, and 3 experience the cache hit, while the data corresponding to subunits 4, 5, 6, and 7 experience the cache miss. In this case, the refill request generation section 302 generates: a refill request 4:Miss for the bank B that manages subunit 4; a refill request 5:Miss for the bank C that manages subunit 5; a refill request 6:Miss for the bank C that manages subunit 6; and a refill request 7:Miss for the bank D that manages subunit 7.

Next, in the cache memory 300, as shown in FIG. 15C, the refill request 4:Miss is stored in the bank B queue 304, the refill request 5:Miss and the refill request 6:Miss are stored in the bank C queue 305 sequentially, and the refill request 7:Miss is stored in the bank D queue 306.

Next, each time the refill request has been stored in each of the bank A queue 303, the bank B queue 304, the bank C queue 305, and the bank D queue 306, the queue control section 307 of the cache memory 300 generates the read access request. However, when the non-combining notification signal has been supplied, as shown in FIG. 15D, the cache memory 300 outputs the refill requests 4:Miss, 5:Miss, 6:Miss, and 7:Miss sequentially as read access requests 1-B, 1-C, 2-C, and 1-D, respectively.

As described above, the cache memory 300 accesses the dynamic random access memory 11 via the system bus 13 while combining the read access requests for the total of four banks A, B, C, and D.

Then, as with the cache memory 14 according to the first embodiment, the cache memory 300 outputs the signal ARCONCAT to acquire the right of using the bus with combined transactions.

As described above, in the image processing apparatus 1, the cache memory 300 performs the read access while combining the read access requests for the total of four banks A, B, C, and D. Accordingly, as in the above-described first embodiment, the pieces of read data can be transferred continuously from the dynamic random access memory 11 to the cache memory 300 via the system bus 13, resulting in an improvement in the utilization ratio of the bandwidth of the dynamic random access memory 11.

Note here that, in the cache memory 300 according to the third embodiment, the refill request generation section 302 generates the refill request for caching the reference image data stored in the dynamic random access memory 11 for the storage area managed by the memory controller 12 on a bank basis in response to the occurrence of the cache miss for the read request. Therefore, a longer time is required for all the refill requests to be stored in the refill request storage section than in the first embodiment. However, since image data of subunits that do not need to be read is never read, the utilization ratio of the bandwidth of the dynamic random access memory 11 can be improved.

Note that, in the above-described first, second, and third embodiments, the dynamic random access memory is divided into four banks. However, this is not essential to the present invention. For example, a dynamic random access memory 11 that is divided into eight banks may be employed in another embodiment of the present invention.

### Fourth Embodiment

In a fourth embodiment of the present invention, the storage area of the dynamic random access memory 11 is divided into eight banks, and the memory controller 12 divides each unit into four parts horizontally and two parts vertically to obtain a total of eight subunits, for example, and allocates data corresponding to each of the eight subunits to one of the eight banks A to H of the storage area of the dynamic random access memory 11 to store the data in that bank.

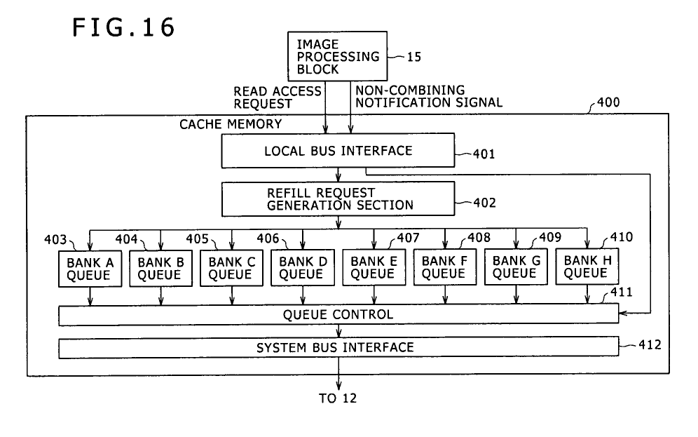

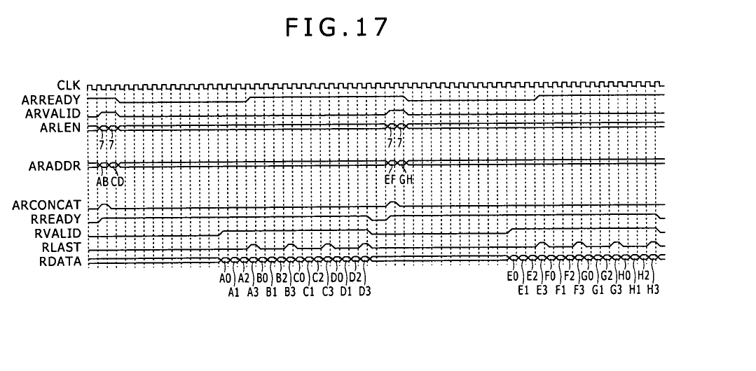

Referring to FIG. 16, in order to access the dynamic random access memory 11 whose storage area is divided by the memory controller 12 into the total of eight banks A to H in the above-described manner, a cache memory 400 includes a local bus interface 401, a refill request generation section 402, two bank A queues 403, a bank B queue 404, a bank C queue 405, a bank D queue 406, a bank E queue 407, a bank F queue 408, a bank G queue 409, a bank H queue 410, a queue control section 411, and a system bus interface 412. The local bus interface 401 exchanges the data with the local bus 153. The refill request generation section 402 generates the refill request for caching the data stored in the dynamic random access memory 11 in response to the occurrence of the cache miss for the read access request made by the image processing block 15. The bank A queue 403 stores the refill request for the bank A. The bank B queue 404 stores the refill request for the bank B. The bank C queue 405 stores the refill request for the bank C. The bank D queue 406 stores the refill request for the bank D. The bank E queue 407 stores the refill request for the bank E. The bank F queue 408 stores the refill request for the bank F. The bank G queue 409 stores the refill request for the bank G. The bank H queue 410 stores the refill request for the bank H. The queue control section 411 controls the output of the read access request in accordance with the refill request. The system bus interface 412 outputs the read access request to the system bus 13.

The local bus interface 401 receives, from the image processing block 15, the read request for reading the desired reference image data and the non-combining notification signal for initiating the read access without combining the refill requests. Then, the local bus interface 401 supplies the read request to the refill request generation section 402, and the non-combining notification signal to the queue control section 411.

If the cache miss occurs in response to the read request, the refill request generation section 402 generates the refill request for caching the reference image data stored in the dynamic random access memory 11 for the storage area managed by the memory controller 12 on a bank basis. Specifically, if the read request is made from the image processing block 15, the refill request generation section 402 determines whether the cache miss has occurred on the basis of the data unit corresponding to the subunit. If the cache miss has occurred, the refill request generation section 402 generates the refill request for the bank that manages data that has experienced the cache miss.

Each of the bank A queue 403, the bank B queue 404, the bank C queue 405, the bank D queue 406, the bank E queue 407, the bank F queue 408, the bank G queue 409, and the bank H queue 410 is a refill request storage section configured to store the refill requests generated by the refill request generation section 402 while the refill requests are distributed therebetween according to the banks managed by the memory controller 12. Specifically, the bank A queue 403 is a refill request storage section configured to store the refill request for the bank A. The bank B queue 404 is a refill request storage section configured to store the refill request for the bank B. The bank C queue 405 is a refill request storage section configured to store the refill request for the bank C. The bank D queue 406 is a refill request storage section configured to store the refill request for the bank D. The bank E queue 407 is a refill request storage section configured to store the refill request for the bank E. The bank F queue 408 is a refill request storage section configured to store the refill request for the bank F. The bank G queue 409 is a refill request storage section configured to store the refill request for the bank G. The bank H queue 410 is a refill request storage section configured to store the refill request for the bank H.

When the refill requests have been stored in four of the bank A queue 403, the bank B queue 404, the bank C queue 405, the bank D queue 406, the bank E queue 407, the bank F queue 408, the bank G queue 409, and the bank H queue 410, the queue control section 411 combines the refill requests for the corresponding four banks and outputs the read access request for the dynamic random access memory 11 to the system bus interface 308.

A reason why the queue control section 411 outputs the read access request when the refill requests have been accumulated for four banks, before the refill requests are accumulated for eight banks, is that a burst length corresponding to the refill requests for four banks corresponds to the burst length which the system bus 13 is capable of transferring at a time. That is, an average of periods of time taken for the refill requests for eight banks to be accumulated in the cache memory 400 is longer than an average of periods of time taken for the refill requests for four banks to be accumulated in the cache memory 400. In addition, even if the queue control section 411 performed the read access when the refill requests have been accumulated for eight banks, the queue control section 411 would make two transfer requests to the system bus 13 while dividing the read access into a read access for the banks A to D and a read access for the banks E to H, for example, as shown in FIG. 17.

Thus, by outputting the read access request to the system bus interface 412 when the refill requests have been accumulated for a specified number of banks corresponding to the burst length that the system bus 13 is capable of transferring at a time, the queue control section 411 is capable of performing the read access to the dynamic random access memory 11 without decreasing the transfer rate because of the aforementioned cause. That is, in the case where the burst length that the system bus 13 is capable of transferring at a time corresponds to a burst length corresponding to refill requests for six banks, the queue control section 411 may operate to make the read access request when the refill requests have been accumulated for six banks.

Meanwhile, if the queue control section 411 receives the non-combining notification signal from the local bus interface 401, the queue control section 411 outputs the read access request to the system bus interface 412 without combining the refill requests, before the refill requests are stored in the specified number of queues.

The system bus interface 412 acquires the right of using the bus from the bus arbiter 13a provided for the system bus 13, and performs the read access to the memory controller 12 via the system bus 13.

As described above, in the image processing apparatus 1, the use of the cache memory 400 according to the fourth embodiment achieves an improvement in the utilization ratio of the bandwidth of the dynamic random access memory 11, even when the read accesses are made to the dynamic random access memory 11 divided into eight banks.

It should be understood by those skilled in the art that various modifications, combinations, sub-combinations and alterations may occur depending on design requirements and other factors insofar as they are within the scope of the appended claims or the equivalents thereof.

1. An information processing apparatus, comprising:
a dynamic random access memory being composed of a plurality of storage elements and requiring a precharge operation of charging each of the storage elements for data storage;
a memory controller configured to manage accesses to said dynamic random access memory on a bank basis, a storage area of said dynamic random access memory being divided into a plurality of banks;
a cache memory connected to said memory controller via a bus and configured to cache data stored in said dynamic random access memory; and
an information processing block configured to perform a read access to said dynamic random access memory via said cache memory, wherein
said cache memory includes
refill request generation means for generating a refill request for caching the data stored in said dynamic random access memory in response to occurrence of a cache miss for the read access performed by said information processing block, the refill request being targeted at one or more of the banks of the storage area managed by said memory controller, and
read access means for, when the refill requests generated by the refill request generation means have been accumulated for a predetermined number of banks among the plurality of banks managed by said memory controller, performing a read access to said dynamic random access memory while combining the refill requests for the predetermined number of banks.

2. The information processing apparatus according to claim 1, wherein,
said memory controller divides each picture of reference image data into a plurality of first image areas, further divides each first image area into a plurality of second image areas, and allocates data corresponding to each second image area to one or more of the banks of the storage area of said dynamic random access memory to store the data in that bank or banks, the reference image data being used in a motion estimation process related to a process of encoding image data to reduce redundancy in the image data or in a motion compensation process related to a process of decoding the data encoded by the encoding process, and
said information processing block performs the motion estimation process or the motion compensation process using the reference image data stored in said dynamic random access memory.

3. The information processing apparatus according to claim 2, wherein said memory controller allocates the data corresponding to each second image area to one or more of the banks of the storage area of said dynamic random access memory to store the data in that bank or banks, the second image areas being obtained by dividing each first image area horizontally and/or vertically.

4. The information processing apparatus according to claim 3, wherein the refill request generation means determines, in response to the read access performed by said information processing block, whether or not the cache miss has occurred on a basis of a data unit corresponding to the second image area, and generates the refill request for the predetermined number of banks, data corresponding to any of the second image areas that have experienced the cache miss and one or more of the second image areas that are adjacent to that second image area being managed by the predetermined number of banks.

5. The information processing apparatus according to claim 3, wherein,
said memory controller divides each first image area into m (m is a positive integer) parts horizontally and n (n is a positive integer) parts vertically to obtain the m×n second image areas, and allocates the data corresponding to each second image area to one or more of the banks of the storage area of said dynamic random access memory to store the data in that bank,
said cache memory further includes
refill request storage means for storing the refill requests generated by the refill request generation means such that the refill requests are distributed according to the banks managed by said memory controller,
the refill request generation means determines, in response to the read access performed by said information processing block, whether or not the cache miss has occurred on a basis of a data unit corresponding to a set of a plurality of adjacent second image areas that are arranged horizontally or vertically, and generates the refill request for a group of a plurality of banks that manage the data that has experienced the cache miss,
the refill request storage means stores the refill requests generated by the refill request generation means such that the refill requests are distributed according to the bank group, and
when the refill requests stored in the refill request storage means have been accumulated for the predetermined number of banks, the read access means performs the read access to said dynamic random access memory while combining the refill requests for the predetermined number of banks to cache the reference image data.

6. The information processing apparatus according to claim 3, wherein,
said cache memory further includes
refill request storage means for storing the refill requests generated by the refill request generation means such that the refill requests are distributed according to the banks managed by said memory controller,
the refill request generation means determines, in response to the read access performed by said information processing block, whether the cache miss has occurred on a basis of a data unit corresponding to the second image area, and generates the refill request for each bank that manages data that has experienced the cache miss,
the refill request storage means stores the refill requests generated by the refill request generation means such that the refill requests are distributed according to the banks, and
when the refill requests stored in the refill request storage means have been accumulated for the predetermined number of banks, the read access means performs the read access to said dynamic random access memory while combining the refill requests for the predetermined number of banks.

7. The information processing apparatus according to claim 5, wherein,
said information processing block supplies, to said cache memory, a non-combining notification signal for initiating the read access without combining the refill requests, and
in response to the non-combining notification signal supplied from said information processing block, the read access means of said cache memory performs the read access to said dynamic random access memory without combining the refill requests stored in the refill request storage means, before the refill requests for the predetermined number of banks have been stored.

8. The information processing apparatus according to claim 3, wherein,
each first image area is divided into two parts both horizontally and vertically to obtain a total of four second image areas, and the storage area of said dynamic random access memory is divided into four banks,
said memory controller allocates data corresponding to the total of four second image areas to the four banks of the storage area of said dynamic random access memory to store the data in the banks,
said information processing block selects current image blocks one after another in a horizontal direction, and reads the reference image data for a process on each selected current image block by performing the read access to said dynamic random access memory via said cache memory, and
said memory controller
sets the number of pixels horizontally arranged in each first image area at approximately twice the number of pixels horizontally arranged in each current image block, and
allocates data corresponding to each pair of second image areas that are side by side horizontally within each first image area to a pair of banks such that the pair of second image areas reverse their sides alternately in each column of the first image areas.

9. The information processing apparatus according to claim 1, wherein,
the bus is connected to another information processing block, and
the other information processing block makes an access to said dynamic random access memory via the bus, when requests for read accesses have been accumulated for the predetermined number of banks among the plurality of banks managed by said memory controller.

10. The information processing apparatus according to claim 1, wherein the read access performed by said information processing block is without limitation on an order of addressing or a transfer length.

11. The information processing apparatus according to claim 1, wherein said cache memory performs only the read access, in relation to said dynamic random access memory.

12. A method for controlling an information processing apparatus,
said information processing apparatus including
a dynamic random access memory being composed of a plurality of storage elements and requiring a precharge operation of charging each of the storage elements for data storage,
a memory controller that manages accesses to the dynamic random access memory on a bank basis, a storage area of the dynamic random access memory being divided into a plurality of banks,
a cache memory that is connected to the memory controller via a bus and which caches data stored in the dynamic random access memory, and
an information processing block that performs a read access to the dynamic random access memory via the cache memory, the method comprising the steps, performed by the cache memory, of:
generating a refill request for caching the data stored in the dynamic random access memory in response to occurrence of a cache miss for the read access performed by the information processing block, the refill request being targeted at one or more of the banks of the storage area of the dynamic random access memory managed by the memory controller; and
when the refill requests generated have been accumulated for a predetermined number of banks among the plurality of banks managed by the memory controller, performing a read access to the dynamic random access memory while combining the refill requests for the predetermined number of banks.

13. The information processing apparatus according to claim 6, wherein,
said information processing block supplies, to said cache memory, a non-combining notification signal for initiating the read access without combining the refill requests, and
in response to the non-combining notification signal supplied from said information processing block, the read access means of said cache memory performs the read access to said dynamic random access memory without combining the refill requests stored in the refill request storage means, before the refill requests for the predetermined number of banks have been stored.
